(19) United States
(12) Patent Application Publication
(10) Pub. No.: US 2026/0341578 A1
(43) Pub. Date: Oct. 29, 2026

(54) Electrical Machine

(71) Applicant: Apotechnos Limited, Kingston upon Thames Surrey (GB)

(72) Inventors: Ashkan Hajiloo, London (GB); Mansour Salehi-Moghadam, Walton-on-Thames (GB)

(21) Appl. No.: 19/106,107

(22) PCT Filed: Aug. 23, 2023
(86) PCT No.: PCT/EP2023/073168

§ 371 Date: Feb. 24, 2025

(30) Foreign Application Priority Data
Aug. 23, 2022 (EP) 22191799.0
May 30, 2023 (EP) 23176226.1

(51) Int. Cl. H01F 27/28; H01F 41/071

(52) U.S. Cl. CPC H01F 27/28; H01F 41/071

(57) ABSTRACT

An alternating current electrical machine comprises a capacitive winding or connection, such as wires capacitively coupled and separated by dielectric and wound into an electromagnetic coil, represented in a circuit diagram by a capacitor. This replaces a conventional coil in machines such as motors, generators, transformers, coils, antenna etc.

### INTRODUCTION

This invention relates to electrical machines, in particular those that have one or more windings.

### BACKGROUND TO THE INVENTION

“Electrical machine”, “electric machine” and like terms are used generally to refer to machines using electromagnetic forces, such as electric motors, electric generators, transformers, and the like. They can convert electromagnetic energy into mechanical energy, or vice versa, or transfer magnetic energy from one winding to another other that is separated via electrical isolation or galvanic isolation. For example, an electric motor converts electricity to mechanical power while an electric generator converts mechanical power to electricity. Further examples are transformers, which change the voltage level of an alternating current. Developing more efficient electric machines has uses and advantages across many electromagnetic applications.

U.S. Pat. No. 7,154,364 discloses an electrical machine having a high voltage winding—this winding uses a convention wire. Other known machines comprise similar such electrical windings in various shapes and forms.

An object of the present invention is to provide alternative electrical machines, with different arrangement of wiring and/or windings; an aim of particular embodiments is to provide an improved electrical machine, for example one that can be made smaller and/or lighter.

### SUMMARY OF THE INVENTION

According to the invention there is provided an electrical machine comprising a capacitive winding (or a capacitive connection). The capacitive winding can be, for example, 2 or more windings that are capacitively connected.

Provided also by the invention is an electrical machine comprising a conductor wound into an electromagnetic coil, wherein the conductor is a capacitive conductor represented in a circuit diagram by a capacitor.

Further provided by the invention is an electrical machine comprising a capacitive winding, being a capacitive wire wound into a coil, wherein the capacitive wire is any wire that has a capacitive coupling within its conductor(s)/conductive element(s) and is represented in a circuit diagram by a capacitor.

Also provided is a method of making a machine of the invention, e.g. as set out above, comprising
providing a capacitive conductor (e.g. wire or cable or conductor) and
forming or making the capacitive conductor into a winding.

The used of a capacitive connection in the winding of an electrical machine provides new machines and new options for machines with notable potential benefit(s).

### DETAILS OF THE INVENTION

An electrical machine of embodiments of the invention comprises a capacitive winding. Suitably, the machine comprises a capacitive connection (e.g. a winding or coil) represented in a circuit diagram by a capacitor.

An electrical machine of the invention may comprise a conductor wound into an electromagnetic coil, wherein the conductor is a capacitive conductor represented in a circuit diagram by a capacitor.

An electrical machine may comprise a capacitive winding, being a capacitive wire wound into a coil, wherein the capacitive wire is any wire that has a capacitive coupling within its conductor/conductive element and is represented in a circuit diagram by a capacitor.

Typically, and as shown in more detail in examples below, the capacitive conductor or capacitive wire or capacitive winding comprises two conductors coupled to each other via a capacitive coupling. The two conductors may be electrically separated from each other by a dielectric material, the dielectric material and the conductors together forming the capacitive coupling.

In a use of the invention, a machine comprising a capacitive winding operates using alternating current (AC) and provides an alternative for or replacement for a known machine that comprises a conventional conductor in its winding.

A conductor can include a wire and/or a cable (e.g. usually with electrical insulation or a sheath or insulator). Conductors may thus comprise a wire, plate, graphene, metal (e.g. aluminium or copper), ferromagnetic or traces or lines on a PCB. Conductors are commonly insulated wires, as used in examples below.

Herein, reference to a winding is believed to be conventional, and refers for example to one or more turns of wire or cable (more generally, a conductor) that form a continuous coil, such as an electromagnetic coil. A winding may be an electrical conductor formed or wound in the shape of a coil, spiral or helix. Electromagnetic windings/coils are used in electrical machines, such as in electric motors, generators, inductors, electromagnets, transformers, chargers, wireless chargers and sensor coils. An AC electric current may be passed through the coil to generate a magnetic field, or conversely, an external time-varying magnetic field may be passed through the interior of the coil to generate an ElectroMagnetic Force (EMF) or voltage in the conductor. The coil or winding may be wound around a coil former. The coil or winding may further comprise a core, suitably ferromagnetic material or ferrimagnetic material, iron in one example, usually to guide and increase the magnetic field generated in use.

While we believe the term is conventional, a “capacitive wire” herein is any wire or cable that has a capacitive coupling within its conductor(s)/conductive element(s). Similarly, a “capacitive conductor” herein is any conductor that has a capacitive coupling within its conductor(s)/conductive element(s). The term “capacitive” does not refer to cable capacitance properties of a conventional conductor such as a conventional power transmission line. It does not refer to capacitance between two isolated conductors in a conventional power transmission line. It refers instead to a wire or cable or conductor that is part of a capacitive transmission system, and which is represented in a circuit diagram by a capacitor. Examples are described e.g. in WO 2010/026380, WO 2019/234449, WO 2021/094783, WO 2021/094782 and WO 2020/120932. In these publications the capacitive wire(s) are sometimes referred to as a Capacitive Transfer System (CTS) connection or CTS cable. Hence, embodiments of the invention use a CTS connection or a CTS cable or conductor wound into a “capacitive winding” and used for one or more windings in an electrical machine. In one use, as described further below, the capacitive nature of the CTS connection may control the current of the AC machine's coil.

The capacitive winding may comprise a conductor and/or there may be a capacitive coupling within the conductor. The conductor of the capacitive winding preferably comprises two conductors or more, preferably coupled to each other, suitably via a capacitive coupling.

Alternatively, or in addition, the conductor may comprise two conductors, such as wires, and these may be electrically separated from each other, for example, by any dielectric and/or insulation medium (or insulator); this can be air in some embodiments. The dielectric material and the wires then together form a capacitive coupling. Suitably, the capacitive winding comprises an electrical conductor, and this may be in the form of a coil, spiral, helix or any other suitable geometric shape.

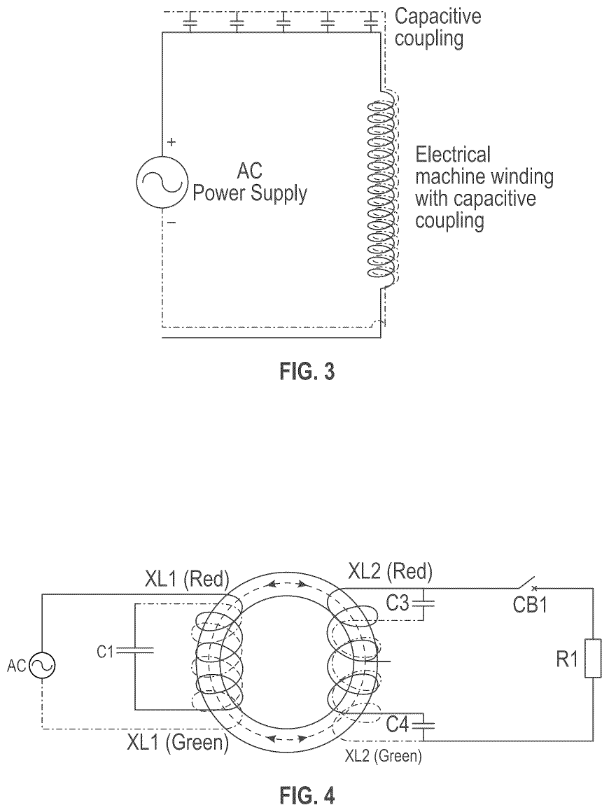

As an example of the invention, therefore, an electrical machine winding comprises two capacitive wires (first and second wires), electrically insulated from each other by dielectric, thus forming a capacitive coupling, with an end of the first wire being connectable to a positive power source side and an end of the second wire being connectable to a negative power source side; these two wires are wound into a coil or winding and used as an alternative for or replacement for a conventional winding or coil (see for example FIG. 3 in the drawings showing such a winding in general terms).

A corresponding method of the invention for making a machine comprises
providing a conductor comprising two or more conductors (e.g. wires) separated by dielectric or insulation medium and forming a capacitive coupling between the two conductors, and
winding or making or forming the conductor into a coil.

In an embodiment of the invention, a capacitive cable comprising intertwined first and second wires, the proximal end of the first connected to a positive terminal of a power source (or ready to be so connected) and the distal end of the second connected to a negative terminal of the power source (or ready to be so connected) is wound into a coil, in one example of approximately 100 turns. This forms the primary coil for a transformer. A second coil of the transformer can be conventional or also made using a capacitive cable. If the primary coil is conventional, as defined herein, the second coil is capacitive (as defined herein).

Suitably, each or all of the capacitive windings has capacitive reactance. The electrical machine may preferably have both inductive and capacitive elements. The or each capacitive winding may generate both magnetic and/or electric fields. Alternatively, the capacitive winding may transfer energy using magnetic and/or electric fields.

Electrical machines comprising windings are widespread. The invention replaces a convention winding with a capacitive winding. Hence, the invention is believed to be of broad application. The electrical machine is suitably a transformer, motor, generator, solenoid, electromagnet, antenna, filter (e.g. in HiFi), furnace, heater, a charger, a wireless power transfer system (e.g. wireless charger) and/or a dynamo. If it is a filter then the machine (or winding) may have resistance, inductance and capacitance. The transformer or AC machine can be coreless, such as a wireless energy transformer, coreless transformer or coreless motor.

The electrical machine in particular embodiments is a transformer. The transformer may further have a capacitor connected to a primary coil and/or a capacitor integrated with the primary coil. Suitably there is no galvanic connection between the coil and the ferromagnetic core. The transformer may be a step-up transformer, step-down transformer, or an isolating transformer.

The electrical machine in particular embodiments is a motor or a generator. The motor can be an induction motor, and specific embodiments of the invention in the form of motors are provided in examples below.

The electrical machine in particular embodiments is a wireless pad, e.g. a charging pad, also sometimes referred to as a ground pad or even a transmitter pad. The charging pad interacts in use with another wireless pad, sometimes referred to as a vehicle pad or receiving pad, to transmit power wirelessly. Either or both may comprise a capacitive winding of the invention. One preferred use is for charging of electric vehicles. The invention provides a wireless charging station comprising a capacitive winding of the invention and/or an electric vehicle comprising a capacitive winding of the invention.

Another use is for charging of mobile telephones, smart phones and other hand-held electrical devices. The invention provides a charging station for a hand-held electrical device comprising a capacitive winding of the invention. The invention also provides a mobile telephone or other hand-held electrical device comprising a capacitive winding of the invention.

Electrical machines of the invention may comprise a secondary capacitive coil or capacitive winding, optionally connected to a capacitor. In an example below, both primary and secondary transformer windings are capacitive windings. In some embodiments, the primary coil is connected to a capacitor in series and/or the secondary coil is connected to a capacitor in parallel.

The number of turns in the winding of the invention varies with intended winding properties and uses. As for conventional windings, those of the invention generally comprise at least 5, at least 20 or at least 50 turns. Further windings of the invention comprise at least 100, at least 300, at least 500 and more turns.

It has been found in use of the invention that electrical machines can be made and used that are smaller and lighter than known machines and yet provide comparable or even improved performance. As a specific example, described in more detail below, a transformer was made using a capacitive winding of the invention and shown to perform as well as a transformer of approximately twice the size and weight made using a conventional winding.

This means that electrical machines of the invention can be advantageous in certain situations where either weight and/or space is an issue, or even at a premium, for example, in the aircraft industry, and in particular electrical machines on or in aircraft. This may be irrespective of the frequency used, so that the weight saving may apply to low (e.g. at about 50 Hz) as well as high frequencies during use.

In general, machines of the invention can operate over a wide range of alternating current frequencies. Embodiments of the invention operate using high frequency AC, say 350 Hz or greater, or 400 Hz or greater, and, separately, up to to 2.8 MHz. In these embodiments, cables are suitably be used wherein each comprises:
(a) a first plurality of conductors for connection to a power source,
(b) a second plurality of conductors for connection to a load, and
(c) a dielectric material between the first plurality of conductors and the second plurality of conductors,
wherein each conductor is individually insulated, and
wherein at least one of the conductors of the first plurality of conductors and at least one of the conductors of the second plurality of conductors are woven or wound into one or more bundles such that each individual conductor repeatedly transitions, along a length of the one or more bundles, between an outside of the one or more bundles and an inside of the one or more bundles.

For such high frequency embodiments of the invention, the electrical machine suitably is made using cabling as described in co-pending European patent applications no's 22209216.5 and 23175297.3. In preferred embodiments, electrical machines are made using Litz wire.

Hitherto, if too much current flows through a winding in a convention electrical machine, then the wire can burn out. In conventional transformers, a greater amount of turns have then been provided in the winding to solve this problem. However, this increases both the size and/or weight of the transformer. By contrast, in electrical machines of the invention, a greater number of turns can be provided without that disadvantage. Thus, instead of including more turns to increase the reactance, the increase in reactance can be achieved by having or including an additional capacitor, or by varying its capacitance. In particular, this can be achieved if a capacitive wire is employed. As a result, the number of turns of the primary coil may not need to be increased to increase the voltage in the primary coil, which means a smaller core can be used.

In some embodiments the capacitive winding may not have sufficient capacitance by itself. One or more additional capacitor(s) can supplement this. These capacitor(s) however should be considered part of the capacitive wire (or cable) and would not usually be considered as being connected in series or in parallel. Instead, these capacitors are better thought of as forming part of a CTS connection.

In certain embodiments the use of capacitive wire (or cable) can mean that the ratio of voltages of the machine windings is no longer dependent on the ratio of the turns of the windings. Instead, the ratio of the capacitance of the two coils can be used to determine the ratio of the voltages. Therefore, e.g. in a transformer, advantageously the primary winding has the same number of turns as the secondary winding, but the ratio of the capacitances between the two windings can determine whether the transformer will be a step-up or step-down transformer.

In embodiments of the invention, such as transformers, the electrical machine comprises two or more capacitive windings and a capacitance controller to vary the ratio of capacitance between the two or more capacitive windings.

The machine can also include dynamic arrangements. If, for example, the capacitance of the circuit on either side of the transformer may be adjustable, the power profile (e.g. the voltage in both windings) can be adjustable as well (often without any need to change the number of turns of either winding).

In embodiments of the invention, the electrical machine comprises a capacitive, power transmission wire comprising:
at least two sets of conductive strands, the strands of the sets being distributed in transverse cross-section of the winding, whereby the sets are in capacitive relation to each other and
   wherein all of the strands of at least one of the sets have:
a respective insulation coating of a dielectric strength to enable the sets of conductive strands to remain isolated from each other.

In these embodiments, at least of the part of the power transmission wire is in the form of a winding.

The conductors or strands will normally comprise copper and/or other conductive material. Normally in the winding there will be the strands of the two or more sets, and these are preferably alternated in their layers.

Whilst one of the sets of conductive strands can be uninsulated, such as with the insulation of the strands of the other set providing the isolation, preferably both or all of the strands have their own insulation. The insulation can be extruded, wound and/or woven, but preferably comprises enamel, typically of the type used in so called “magnet wire”.

The machine may comprise soft polymer insulation, such as between each layer, e.g. to fill interstices between individual strands.

Preferably, the respective insulations of the sets will be differently coloured, for example to allow their separation for connection at opposite ends of the winding. Where more than two sets of strands are provided, they may each have a respective colour.

Where both electrode sets of conductors have identical enamel insulation, they will not usually be visually distinguishable. However, it is envisaged that they can be identified individually at one end by application of an electrical signal to them at the other. Conveniently, the conductors will be grouped together into one electrode set at the other end, and indeed preferably be connected together, with the signal applied and then sorted at the one end to identify the other electrode according to whether the signal is present or not on individual conductors.

The invention may use a capacitive, power transmission cable comprising:
at least two sets of conductive strands, the conductive strands being
   laid in layers of opposite twist, with
   the strands of one or more adjacent layers being of all one set and then radially outwards the strands of one or more adjacent layers being of all another set and
insulation between the layers of different sets, whereby the at least two sets are in capacitive relation to each other.

The invention is not intended to be restricted to the details of the above-described embodiment. For instance, more or fewer conductive layers can be provided. They can be provided as an even number as above or an uneven number of conductive cylinders with the inner and outer most interconnected.

For connection of a first capacitive winding to a second capacitive winding conductor, a connector block can be provided with terminals for the first and second sets of conductors. The block facilitates connection of the wires as a capacitive wire, with one set of conductors connected in use to the first set in connecting winding and the second set of conductors connected to the second set in the connecting winding.

The above-described windings, including the variants, are connected in essentially the same way in that the strands of the one set, typically the red set, are bundled and at both ends and the strands of the other set are bundled in a like manner. After division into respective bundles, the enamel is stripped from the ends of the strands. The stripped strands are soldered or inserted into respective terminal block and tightly clamped together, providing mechanical and more importantly electrical connection.

Where the winding is to be used as a single length between a supply positive and negative or neutral, the electrical connection of the winding is between the first set of wires and the second set of wires as an elongate or distributed capacitor. At the winding beginning, the first set of conductors is permanently connected to the positive or supply side of power source. At the winding end the second set of conductors is permanently connected to the negative or neutral side of power source. The remaining sets are terminated in isolated terminals on the respective side of the winding. Alternatively, or in addition, a separate set of conductors can be connected at both ends to provide a straight through connection.

Cables with three or more sets of cables can be used to further choose the capacitance of the cable, by adding conductors of a third set in parallel to those of the first set for instance and of a fourth set in parallel to those of the first set, the third and fourth sets being capacitively connected.

For choice of the capacitance of the winding, account is taken of the inductance of the winding and other components of the electrical system of which the electrical machine is part, with a view to balancing or altering this inductance with the capacitance of the winding. More specifically, the following steps may be used:
1. Selecting an initial winding size in accordance with the voltage and current that the winding is to carry, in particular, the cross-sectional area of metal or insulated filler replacing the core to be included; and on a first iteration the number of enamelled wires and/or the number of layers;
2. Computing the design inductance of the winding (L_{D}) and the resistance of the winding wire (R) using computer simulation and modelling and including in particular its inherent inductance and any mutual inductance that may result from its inclusion in an electrical machine system,
3. Noting that for the inductive reactance for the winding resulting from L_{D} is given by the Inductive Reactance Equation:

X_{L}=2πfL_{D}
where f equals the operating frequency in Hz;
4. Noting that for the capacitive reactance of the winding, for a capacitance C is given by the Capacitive Reactance Equation:

X_{C}=½πfC
where f equals the operating frequency in Hz;
5. If other elements of the machine inductance are to be balanced. This can be taken account of by modifying the values of L_{D} and thus X_{L}; and
6. The resulting design is then modelled in simulation to validate the original inductance computation L_{D} and the resulting X_{L} and X_{C} which may suggest design revision. One or more further iterations may be required.

The above steps take account of the fact that even for magnet wire enamel the withstand strength of a dielectric does not rise linearly with voltage, as shown in FIG. 12 for selected, but non-exhaustive, dielectric materials.

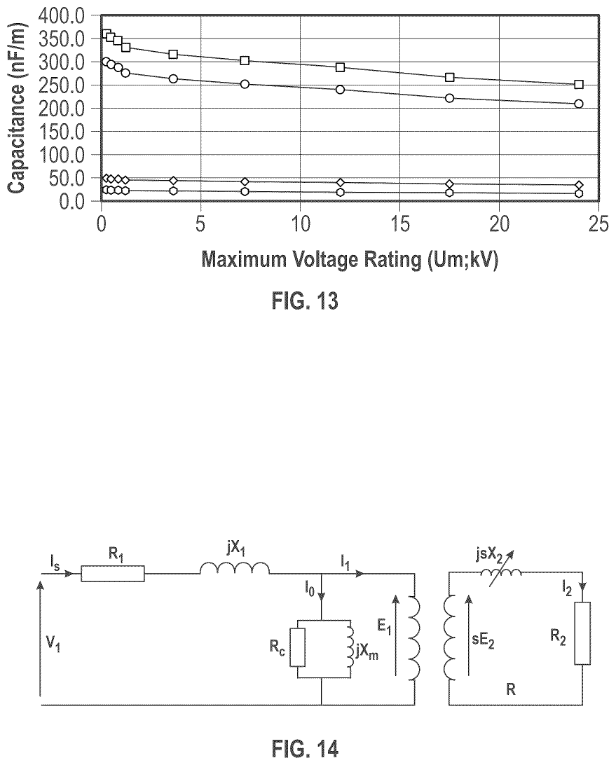

It will be noted that the selection of dielectric is defined by the application voltage and required capacitance. To give an appreciation of their relative values, the relationship can be observed as shown in FIG. 13 for selected, but non-exhaustive, dielectric materials.

If the capacitance of the combined lengths needs to be less, the connector can be a series connector. With a (winding A) first set to second set connection (winding B) between the two windings, the free ends capacitance is between the first set wires of winding A and the second set wires of winding B. The capacitance is in effect of a single length with double the dielectric gap. It is given by the formula for capacitances in series:

$$\begin{matrix}Series Capacitances & \\ {C}_{total} = \frac{1}{\frac{1}{{C}_{1}} + \frac{1}{{C}_{2}} + … \frac{1}{{C}_{π}}} . & \end{matrix}$$

Where the two lengths are identical, the total winding capacitance is halved.

A feature of capacitances in series is that the voltage across individual ones is divided by the number of capacitances. This is useful in enabling a high voltage line to be comprised of three sections, each carrying ⅓ of the high voltage. This has further advantages in reducing the thickness of the dielectric coating or tape/paper between the conductors. Thus loss of capacitance by connection in series can be offset by higher capacitance per unit length in the first place.

Various types of wires, cables and conductors can be used in the present invention.
1. IEC 60317 (Specifications for particular types of winding wires)
The following IEC standard governs various formats of an “enamelled” conductive wires that are used for winding applications. This format diverges into conductive material (Cu, Al, or conductive spray, etc) and shape of conductor (tape, rectangular wire, round wire, etc) and enamel material as well.
This standard is an example of how thin/thick the enamel strands can be such that they can be more physically applicable for a given embodiment or winding application. The variants of enamelled wire contains strand sizes ranging from 0.01 mm to 0.5 mm.
This standard is used to give types of wires/conductors that can be used effectively to create a capacitive winding/wire depending on size of the machine, environment etc. The invention can use any suitable form of conductor and dielectric to establish the capacitive link.
2. Dual/Multi-Embodiment (Cable/Wire+Electrical Machine Winding) Within One Product
The concept is to provide an avenue in which the wire/connection can be used both as a feeder cable/wire and an electrical machine winding i.e. simultaneous use of one product for two (or more) applications. The cable can have very thin insulation (tape wrapping) over the conductor bunch.
The cable/wire can be connected to a conventional AC electrical machine or connected to an electrical machine with capacitive winding or use one wiring to accommodate two applications.

To help understanding of the invention, embodiments thereof are described herein above and below by way of example and with reference to the accompanying drawings, in which:

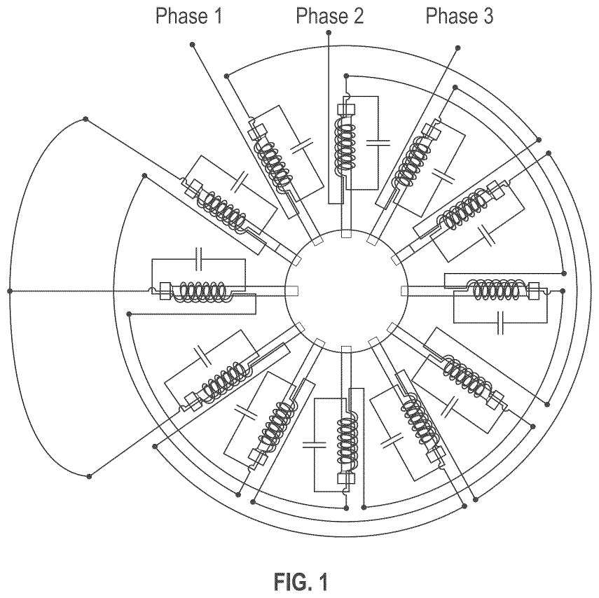

FIG. 1 is a schematic diagram of an induction motor with a capacitive winding of the invention in delta connection;

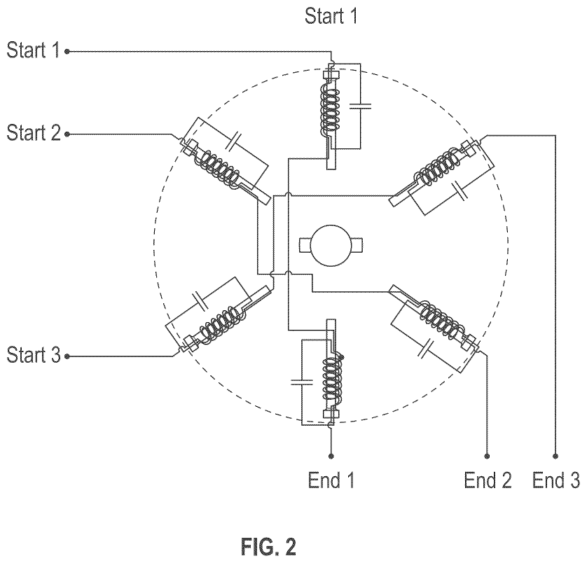

FIG. 2 is a schematic diagram of an induction motor with a capacitive winding of the invention in star connection;

FIG. 3 shows a schematic circuit diagram of a capacitive winding of the invention in generalised form;

FIG. 4 shows a schematic diagram of a first transformer of the invention;

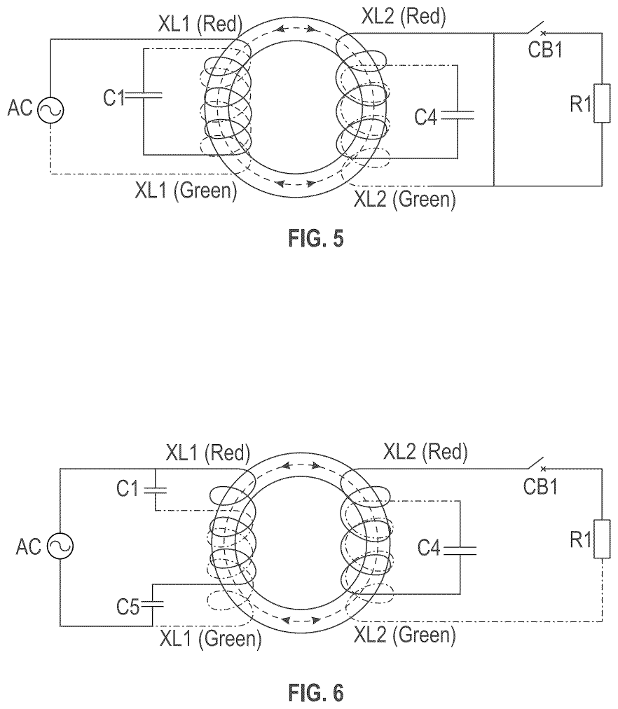

FIG. 5 shows a schematic diagram or a second transformer of the invention;

FIG. 6 shows a schematic diagram of a third transformer of the invention;

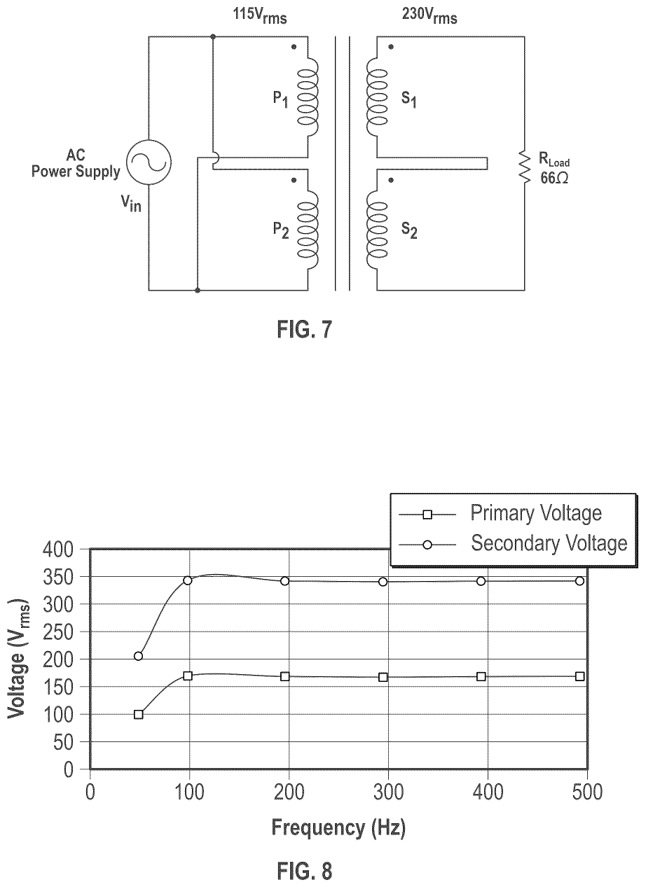

FIG. 7 shows a schematic diagram of a conventional transformer (not part of the present invention);

FIG. 8 shows operating performance of the transformer of FIG. 7;

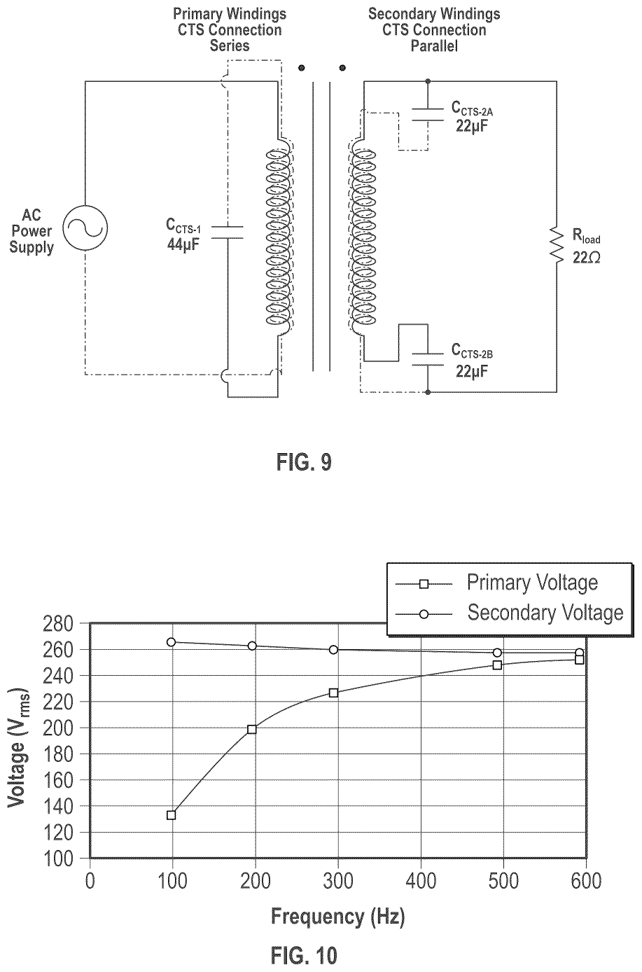

FIG. 9 shows a schematic diagram of a transformer of the invention designed to replace that of FIG. 7;

FIG. 10 shows operating performance of the transformer of FIG. 9;

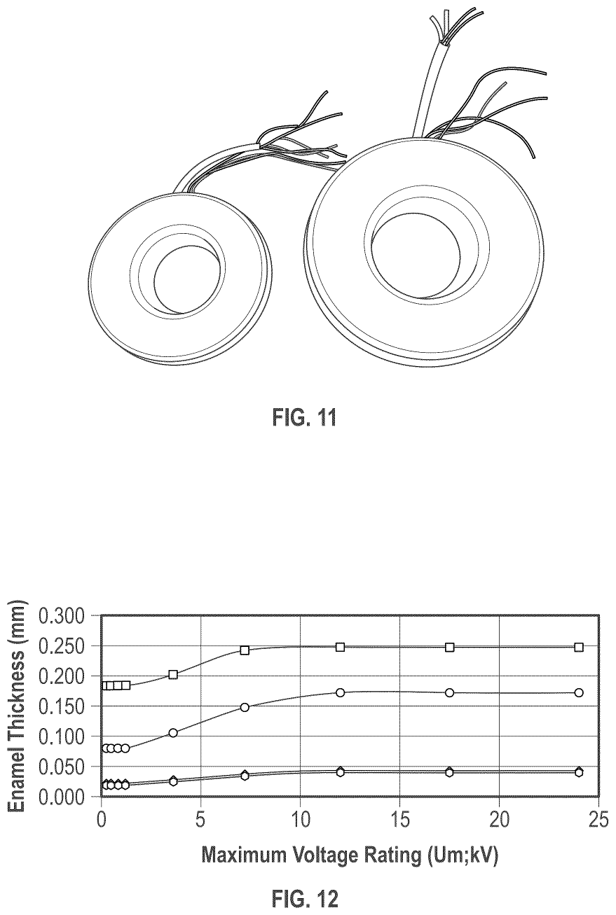

FIG. 11 shows a transformer of the invention (left hand side) and a conventional transformer (right hand side) of equivalent performance, showing their respective sizes;

FIG. 12 shows rise of withstand strength of a dielectric with voltage, for selected dielectric materials;

FIG. 13 shows the relationship between application voltage and required capacitance for selected dielectric materials;

FIG. 14 shows a circuit diagram of an induction motor with a conventional winding (not part of the present invention);

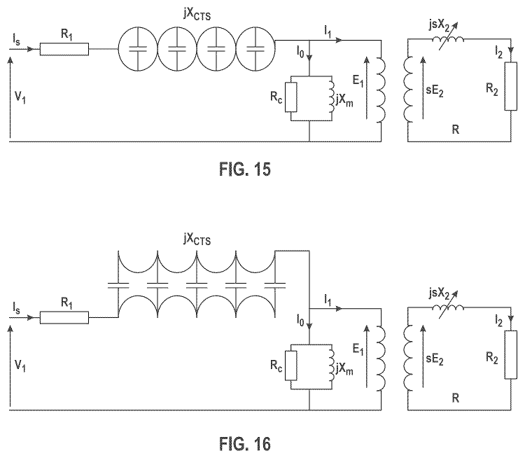

FIGS. 15 and 16 show circuit diagrams of electrical machines of the invention with a capacitive winding;

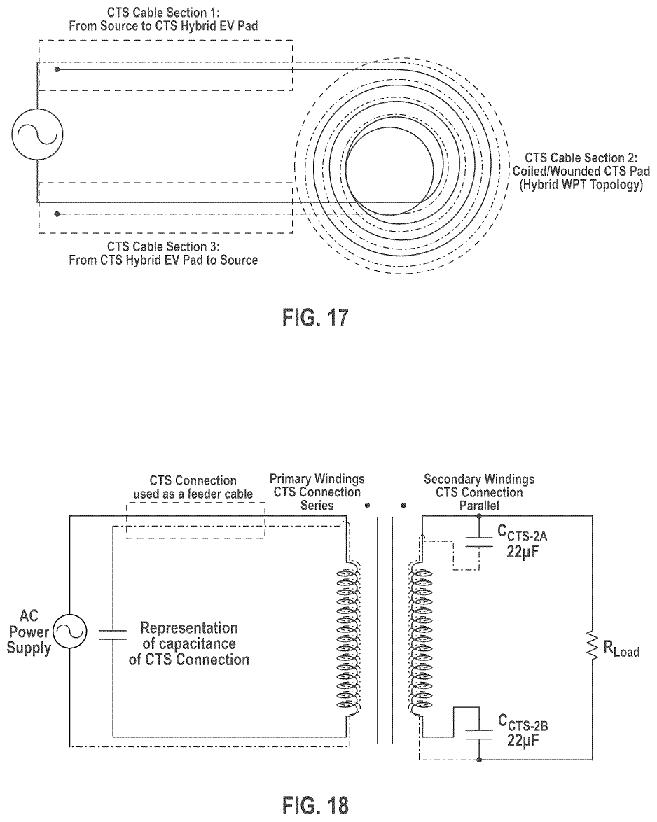

FIG. 17 shows a circuit diagram for an electric vehicle charging plate incorporating a capacitive coil of the invention; and

FIG. 18 shows a circuit diagram of a transformer of the invention using high frequency CTS cable both as a feeder cable and for the winding.

### EXAMPLES

Referring generally to the examples there are shown embodiments of the invention in which a machine comprises a capacitive winding, represented in circuit diagrams as a capacitor.

A circuit diagram of a machine of the invention is shown schematically in FIG. 3. A capacitive cable, in the form of two wires separate by dielectric is wound into a coil. One wire is connected to the positive side of a power supply and the other to the negative side.

The electrical connection between the two wires is capacitive, shown by capacitors in the circuit diagram.

### Example 1—Transformers

### Model 1 (Step Down) if Number of Turns is Same

A first transformer of the invention is shown schematically in FIG. 4.

The transformer has a capacitive winding on each side of a ferrite core. The incorporation of the capacitive reactance in the primary winding limits the current utilised to excite the core i.e. generate the flux that links the primary and secondary winding. As a result, the primary voltage can increase beyond the point which would have generated a current that would saturate the current, for example at 50 Hz compared to the conventional counterpart. On the other hand, the reduced current will reduce the voltage induced in the secondary winding due to the reduced primary current.

### Model 2 (Same Level) if Number of Turns is the Same

A second transformer of the invention is shown schematically in FIG. 5.

This model 2 is a transformer where the capacitance of both cell coils is the same. This means that the voltage of both coils will be the same too. A 12V input at the primary coil induces a 12V output in the secondary coil. This may be useful if a circuit is designed and it is beneficial to keep two parts of the circuit electrically isolated from each other.

### Model 3 (Step UP) if Number of Turns is the Same

A third transformer of the invention is shown schematically in FIG. 6.

Model 3 is the inverse of model 1; the capacitors are connected differently in the circuit. This system can also be applied to motors that involve transformers. This is because it is beneficial to develop smaller transformers for motors as this allows smaller motors to be produced, or motors of the same size with greater power. This is particularly useful for electric vehicles and/or drones.

Model 4 (not shown) is a transformer where the core is laminated to reduce eddy current formation. Prior art transformers transfer power usually exclusively using magnetic fields. However, by connecting the laminae to the circuit this can enable the growing and collapsing electric fields to be harnessed as well.

In conventional transformers, it may be of little consequence if the coating of the laminae becomes compromised, because these do not form part of the electrical circuit. However, in the invention, it is preferred that the different laminae are kept dielectrically isolated from each other, in their CTS transformer, as these form part of the circuit.

Model 5 (not shown) is a similar set up to model 4, but wherein both of the laminae are connected to the circuit on one side of the transformer. This is in contrast to mode 4 which shows one set of laminae connected to the circuit to the primary side of the transformer and the other laminae connected to the circuit on the secondary side of the transformer.

One problem often encountered in the prior art is that there is a limit to the magnitude of the magnetic field that can be induced in a ferromagnetic core. This is because the core is comprised of many microscopic regions called magnetic domains, of which there are a fixed number in the core of a given size. The magnetic field of each of these domains is orientated randomly until the current in the primary coil induces a magnetic field in the core, at which point the magnetic fields of the domains in the core become aligned. The stronger magnetic field is induced in the core when the magnetic domains become more closely aligned. However, this means that there is a limit to the magnitude of the magnetic field that may form around the core, and this maximum corresponds to a state in which the magnetic domains of the core are aligned perfectly. At this point any further increase in the turns of the primary coil would not result in an increase in the strength of the magnetic field generated around the core, which means that no additional power will be transmitted to the secondary coil. At this point the ferromagnetic core is said to have become saturated.

In order to address the issue of saturation and transfer additional power, a larger ferromagnetic core can be used. This provides a greater number of magnetic domains, which allows the stronger magnetic field to be induced before saturation is achieved. For this reason, though, prior art transformers tend to be physically large.

It is thus desirable to develop a system whereby the power transferred across the transformer could be increased without requiring a larger ferromagnetic core, to be used to prevent the core from being saturated.

By making the primary and secondary cables from capacitive cables there may be no need to increase the frequency of the input alternative current to increase the inductive reactants of the cable. There may also be no need to increase the number of turns on the coils. The result of this is that greater power could be transferred across the transformer without needing to increase the size of the ferromagnetic core. The invention therefore allows smaller transformers to be produced.

One of the benefits of the invention, and using high frequency power transmission, is that it allows smaller electrical components to be used. This may be because the magnetic fields used, for example in transformers, grow and collapse more times per second. For example, in aircraft, they use a frequency of 400 Hz. This allows components to be eight times smaller than if 50 Hz was used instead.

Aircraft often need to connect to a power supply from the airport when they arrive at the gate. Given that the power supply to the airport is at a frequency of 50 Hz then a converted is needed at each end to convert this to 400 Hz.

A converter works by receiving an AC input, converting this to DC, and then running this DC through a second stage of the converter, known as an “inverter”, which converts this to AC (but at a different frequency to the input AC). One advantage of the invention, in a high frequency power distribution network, is to remove the need to provide a converter at each gate. Instead, a network can be provided where a single converter in provided at the airport and the power cables at each gate are connected to this.

In the present invention there can be no ohmic, i.e. conductive, connection from one end of the coil to the other in (for example, in the CTS transformer). The reactance of the capacitor and the reactance of the inductor may be in opposite vector directions. As a result of much larger capacitance, the net capacitance is increased. In transformers of the invention, the core laminae (layers, or laminate) are also acting as capacitors. This enables both the magnetic but also the electric fields to be leveraged. Here there may a benefit, for example for wireless charging.

In model 1 and model 2 the number of turns shown in each of the coils is the same. In model 1, this can be thought of as comprising four wires arranged into two coils. The primary coil comprises two of these and the secondary coil comprises the other two.

In the primary coil (left) on model 1, the red and green wires are connected in series with capacitor C1 connected between them. Both wires are coiled around the one of the core to produce the primary coil. However, in the secondary coil the red and green wires are connected in parallel, again with capacitors between them. Just like the primary coil, both wires of the secondary coil are coiled around a side of the core to produce the secondary coil.

The result of having a primary coil wherein two wires are connected in series and the secondary coil where the two wires are connected in parallel, is that the primary coil is affectively twice as long as the secondary coil (assuming all four wires are in the same length). This means that the primary coil effectively contains twice as many turns as the secondary coil (again, assuming the number of turns in all 4 wires is the same). The result of this 2:1 ratio of turns between the primary and secondary coil is a 2:1 ratio in the voltage between the primary and secondary coils. Accordingly, model 1 depicts a step-down transformer wherein the voltage is reduced by 50% across the transformer.

Model 3 is essentially the inverse of model 1. In this case the two wires of the primary coil are connected in parallel and the two wires of the secondary coil are connected in series. Accordingly, model 3 depicts a step-up transformer wherein the voltage is doubled across the transformer.

In the invention, a different ratio of turns between the two coils, for example not 2:1 or 1:2 can be used. The fact to determine the voltage change across the transformer i.e. the amount of capacitance of each coil, does not affect this.

Although the amount of capacitance in each coil may not influence the voltage change across the transformer, this may serve another important purpose, namely to limit the flow of the current. If the reactance of the coil is too low then the current flowing through the coil will be too high and the wire will burn out. In conventional transformers this is addressed by increasing the number of turns of each coil. However, if capacitors are included then there may be no need to add additional turns to increase the reactance. The capacitors will fulfil this role instead. If no additional turns are needed, the coils can thus be made shorter, which means that transformers as a whole can be made smaller.

In prior art transformers, these are normally configured to operate at a particular input voltage, for example 100 volts. Voltage of course is proportional to current (V=IR). Given the resistance is fixed because the number of turns in the coil is fixed, then if a transformer is run using an input voltage of 100 Volts, then the current will increase to compensate which may cause the wire to burn out. This may not be a problem with the invention because whilst it is equally impractical to modify the number of turns, the amount of capacitance could be changed to account for this difference. This may make it easier to change the voltage transferred across the transformer than using a conventional transformer. This is what is known as a dynamic arrangement in the invention.

It should be noted that this does not change the ratio of voltages between the coils (2:1, 5:1 etc). This ratio is only influenced by the number of turns of each of the respective primary and secondary coils.

In most of the embodiments it is possible to determine the capacitance needed as the voltage is known. This applies equally to electric motors and wireless electric vehicle charging. In the case of wireless electrical charging, the transmitter can be thought of as similar set up to this transformer but without a ferromagnetic coil present i.e. two coils with a magnetic field between them. The absence of the core in this case means that the energy transfer may be less sufficient than in a transformer because in transformers, the core acts to direct the magnetic field.

In the case above, the red and blue laminations indicate laminations electrically connected to the red and blue wires in the primary and secondary coils respectively. Because the laminations are dielectrically isolated from each other by a layer of insulation these act as capacitors. As a result the energy in the eddy currents that arise in these laminations can be harnessed and be used in the energy transfer across the transformer. In prior art transformers these eddy currents account only for energy loses.

Model 5 is a similar set up to mode 4, but wherein both sets of laminations are corrected to wires in the same coil rather than in opposite coils.

Capacitive Transformer vs. Conventional Transformer

The invention has been illustrated by disassembling and reconfiguring the primary/secondary windings of a conventional transformer using capacitive windings.

The conventional transformer had the following features:

| Transformer Model | RS 1176082 |
|---|---|
| Topology | Twin Primary/Twin Secondary |
| | winding toroidal transformer |
| Voltage Rating of Each Winding (Vᵣₘₛ) | 115 |
| Number of Turns for Each Winding | 166 |
| Apparent Power Rating (kVA) | 1 |
| Weight (Kg) | 7.8 |

The conventional transformer was operated within a frequency range to demonstrate the behaviour of the turns' ratio and the opportunity presented when incorporating CTS connection in the winding.

In the conventional transformer, the two primary windings are connected in parallel (P₁//P₂) and subsequently, the two secondary windings connected in series (S1+S2). This set-up would set the turns ratio in the transformer winding to 1:2 (Nₚ:Nₛ), hence a step-up transformer topology is established, and a conventional transformer equivalent circuit is shown schematically in FIG. 7.

Transformer operation (connected to a 66Ω load) was tested experimentally. During the experiment, the transformer core saturated when Vp was increased to 115 volts at 50 Hz due to the primary current exceeding the magnetic field strength threshold of the given core. When increasing the supply frequency, for a given primary voltage and turns ratio, the secondary voltage experienced minimal changes and the transformer winding relationship remained applicable i.e. continues to operate as a step-up transformer. The operating performance is shown in FIG. 8.

However, when converting the winding topology from a conventional to a transformer of the invention i.e. introducing a capacitive element as explained in the invention into the transformer windings, the turns ratio relationship is no longer the main factor defining windings parameters such as voltage and current. Instead, the reactance of the winding (capacitive and inductive) and its accompanying parameters such as frequency will contribute towards the mode/topology (step-down, isolation or step-up) of the transformer.

We designed and made a transformer of the invention of the same rating (and turns) as the conventional counterpart above but utilising a capacitive winding of the invention in both windings. The primary and secondary windings were connected in series and parallel respectively to establish a step-down transformer in accordance with the transformer turns ratio rule.

FIG. 9 shows the equivalent circuit of this transformer incorporating capacitive windings on both windings (Step-down) according to the invention.

The incorporation of the capacitive reactance in the primary winding limits the current utilised to excite the core i.e. generate the flux that links the primary and secondary winding. As a result, the primary voltage can increase beyond the point which would have generated a current that would saturate the current, for example at 50 Hz compared to the conventional counterpart. On the other hand, the reduced current reduces the voltage induced in the secondary winding due to the reduced primary current.

Furthermore, since there are both inductive and capacitive elements present in the winding, the resultant reactance will change as the supply frequency varies. One of the observed changes is the variable voltage ratio (Vp:Vs) that is independent of the winding turns ratio. At approximately 100 Hz, the transformer is operating in a step-down mode. As the frequency increases, the inductive reactance increases while the capacitive reactance decreases.

In return, the voltage induced in the secondary winding increases for the same primary voltage due to the change in the current distribution between the inductive and capacitive element. at nearly 600 Hz, the reactance has been substantially minimised (as shown in the rise of power factor) and the transformer now behaves as an isolation transformer. Further increase in frequency will cause X_{L} to be greater than X_{C} and change the operation into a step-up transformer. The reactance minimisation in the winding, allows for creating a greater power capacity.

As demonstrated in the above operation, when the frequency is below 600 Hz, the transformer operates in CTS mode (X_{L}<X_{C}) but when frequency reaches and increases beyond 600 Hz, the transformer revert into a conventional variant as X_{L} is the dominating reactance in the winding (X_{L}>X_{C}).

The rise in the supply frequency enables the reactive elements in the winding to charge and discharge at a faster rate compared to the conventional 50 Hz, which enables transferring a higher power in both the conventional and CTS models while avoiding saturation. This also demonstrates the compatibility of the CTS connection for higher frequency operation. However, it should be noted that additional increase in the frequency beyond a certain threshold will increase the eddy current and contribute towards the power losses in the core (Core frequency compatibility becomes essential).

Having made the transformer of the invention we tested it for comparison with the conventional version. The performance of this transformer of the invention is shown in FIG. 10.

One of the major design outcomes was a reduction in the size of the CTS transformer core while transferring the same power as a conventional counterpart which relies on a larger core—see FIG. 11, showing side by side the conventional transformer and the equivalent transformer built according to the invention.

### Example 2—Motors

FIGS. 1 and 2 show schematic diagrams of motors comprising capacitive windings according to the invention (a general winding in FIG. 1 and a star-connection in FIG. 2).

FIG. 14 shows an equivalent circuit of a conventional induction motor with a conventional winding:
V₁=input voltage (source voltage)
R1=the resistance of the stator winding, Ω
X1=the stator leakage reactance (Winding), Ω
Xm=Magnetising reactance of stator Ω
Rc=core losses (hysteresis and eddy current)
I1, Is=stator current, A
I₀=magnetization current, A
E1=Stator induced EMF
S=slip
E2=EMF induced in the rotor
T=motor torque, N·m
I2=rotor current, A
X2=rotor circuit reactance, Ω
R2=rotor circuit resistance, Ω

FIGS. 15 and 16 show equivalent circuit diagrams representing an electrical machine with a capacitive winding of the invention:
V₁=input voltage (source voltage)
R1=the resistance of the stator winding, Ω
X_{cts}=Stator CTS reactance (Winding), Ω
Xm=Magnetising reactance of stator, Ω
Rc=core losses (hysteresis and eddy current)
I1, Is=stator current, A
I₀=magnetization current, A
E1=Stator induced EMF
S=slip
E2=EMF induced in the rotor
T=motor torque, N·m
I2=rotor current, A
X2=rotor circuit reactance, Ω
R2=rotor circuit resistance, Ω

### Example 3—Wireless Charging Plate

We used capacitive cables and high frequency AC in a feeder cable and a primary electrical vehicle (EV) wireless charging plate (also referred to as a charging pad). In this example, while in self-compensation mode, the CTS cable goes from an inverter, is wound to form a coil and is returned back to the inverter to form the circuit i.e. the cable is an uninterrupted continuous loop through the coil and back to inverter. Therefore, inherently, the coiled cable i.e. the primary pad will incorporate capacitive and inductive properties (i.e. hybrid wireless power transfer (WPT) due to physical elements representing the inductor (coil) and capacitor (CTS terminals)).

The CTS capacitance compensates for the reactance of the coil and the cable simultaneously.

The plate incorporating a coil of the invention is shown schematically in FIG. 17.

In section 1 there is a capacitive coupling between a first cable connected to the source and a second cable (not connect to the source). The pair of cables continue to the pad.

In section 2 the pad comprises the two cables, again capacitively coupled and wound into the pad coil, then exiting towards section 3.

In section 3, the cables remain capacitively coupled exiting the pad and the second cable is connected back to the other side of the source, though the first cable is not-hence a capacitive winding is provided in the coil of the charging pad.

### Example 4

In a development of the transformer described in example 1, we used high frequency CTS cable both as a feeder cable and for the winding in a design for a further transformer of the invention, shown schematically in FIG. 18.

Thus, a capacitive conductor, using an insulated conductor or wire or cable, is used in the form of a winding in an electrical machine.

1. An electrical machine comprising a conductor wound into an electromagnetic coil, wherein the conductor is a capacitive conductor represented in a circuit diagram by a capacitor.

2. An electrical machine comprising a capacitive winding, being a capacitive wire wound into a coil, wherein the capacitive wire is any wire that has a capacitive coupling within its conductor/conductive element and is represented in a circuit diagram by a capacitor.

3. An electrical machine according to claim 1 or 2, wherein the capacitive conductor or capacitive wire comprises two conductors coupled to each other via a capacitive coupling.

4. An electrical machine according to claim 3, wherein the two conductors are electrically separated from each other by a dielectric material, the dielectric material and the conductors together forming the capacitive coupling.

5. An electrical machine according to any preceding claim, comprising an electrical conductor in the form of a coil, spiral or helix.

6. An electrical machine according to claim 5, comprising two or more conductors wound in a coil, spiral or helix.

7. An electrical machine according to any preceding claim, wherein the electrical machine is a transformer (optionally comprising a ferromagnetic core), motor, generator, solenoid, electromagnet, antenna, furnace, heater, (wireless) charger or a dynamo.

8. A transformer according to claim 7, wherein the transformer further comprises a capacitor connected to a primary coil and/or a capacitor integrated with the primary coil.

9. A transformer according to claim 7 or 8, wherein the transformer is a step-up transformer, step-down transformer or isolating transformer.

10. A transformer according to any of claims 7 to 9, comprising a secondary coil (or winding) connected to a capacitor.

11. A transformer according to any of claims 9 to 10, wherein the primary coil is connected to a capacitor in series and/or the secondary coil is connected to a capacitor in parallel.

12. A motor according to claim 7.

13. A generator according to claim 7.

14. An electromagnet according to claim 7.

15. An antenna according to claim 7.

16. A furnace according to claim 7.

17. A heater according to claim 7.

18. A charger according to claim 7.

19. A wireless charger according to claim 7.

20. A solenoid according to claim 7.

21. A dynamo according to claim 7.

22. A method of making an electrical machine according to any previous claim, comprising
providing a cable or wire or conductor comprising two conductors separated by a dielectric,
forming a capacitive connection therebetween, and
winding or otherwise making the cable or wire or conductor into a coil.

23. An electrical machine comprising a capacitive winding.

24. An electrical machine according to claim 23 which comprises a capacitive connection (winding, coil or other means to induce magnetic field), represented in a circuit diagram by a capacitor.

25. An electrical machine according to claim 23, wherein the capacitive winding comprises a conductor and there is a capacitive coupling within the conductor, represented in a circuit diagram by a capacitor.

26. An electrical machine according to claim 25, wherein the conductor of the capacitive winding comprises two conductors coupled to each other via a capacitive coupling.

27. An electrical machine according to claim 25 or claim 26, wherein the conductor comprises two conductors, such as wires, electrically separated from each other by a dielectric material, the dielectric material and the conducting wires together forming the capacitive coupling.

28. An electrical machine according to any of claims 23 to 27, wherein the capacitive winding comprises an electrical conductor in the form of a coil, spiral or helix.

29. An electrical machine according to claim 28, comprising two or more capacitive windings each comprising one or more electrical conductors wound in a coil, spiral, or helix.
